(19) United States
(12) Patent Application Publication
(10) Pub. No.: US 2008/0050643 A1
(43) Pub. Date: Feb. 28, 2008

(54) ELECTRICALLY CONDUCTIVE LANDS ADHERED TO GAS DIFFUSION MEDIA AND METHODS OF MAKING AND USING THE SAME

(75) Inventors: Mahmoud H. Abd Elhamid, Grosse Pointe Woods, MI (US); Gayatri Vyas, Rochester Hills, MI (US); Youssef M. Mikhail, Sterling Heights, MI (US); Thomas A. Trabold, Pittsford, NY (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/466,824

(22) Filed: Aug. 24, 2006

(51) Int. Cl. H01M 4/94; H01M 4/88; B05D 5/12

(52) U.S. Cl. 429/44; 429/42; 502/101; 427/115; 429/38

(57) ABSTRACT

A product including a fuel cell gas diffusion media layer and a plurality of electrically conductive lands secured thereto.

### TECHNICAL FIELD

The field to which the disclosure generally relates includes gas diffusion media, products made therefrom, and methods of making and using the same.

### BACKGROUND

Fuel cell stacks are known to include a plurality of bipolar plates which are used to collect and distribute electrons in the operation of fuel cell stack. The bipolar plates may be made from a metal, such as stainless steel, that has a passive oxide thereon. The passive oxide increases contact resistance and impacts fuel cell performance.

### SUMMARY OF EXEMPLARY EMBODIMENTS OF THE INVENTION

One embodiment of the invention includes a gas diffusion media having a plurality of electrically conductive lands secured thereto.

Other exemplary embodiments of the present invention will become apparent from the detailed description provided hereinafter. It should be understood that the detailed description and specific examples, while indicating the exemplary embodiment of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings.

FIG. 1 illustrates a product including a gas diffusion media with a plurality of electrically conductive lands secured thereto, according to one embodiment of the invention.

FIG. 2 is a plan view of a product including a gas diffusion media having a plurality of electrically conductive lands thereon wherein the electrically conductive lands are positioned to run substantially parallel to the lands of a bipolar plate in a fuel cell, according to one embodiment of the invention.

FIG. 3 is a plan view of a product including a gas diffusion media including a plurality of electrically conductive lands secured thereto wherein the electrically conductive lands are positioned to run substantially perpendicular to lands of a bipolar plate in a fuel cell, according to one embodiment of the invention.

FIG. 4 is a plan view of a product including a gas diffusion media including a plurality of electrically conductive lands secured thereto, and wherein the electrically conductive lands are positioned to run in a skewed direction with respect to the lands of a bipolar plate of a fuel cell, according to one embodiment of the invention.

FIG. 5 is a sectional view of a product including a gas diffusion media and a plurality of electrically conductive lands secured thereto, according to one embodiment of the invention.

FIG. 6 illustrates a product including a gas diffusion media and a plurality of electrically conductive lands secured thereto by way of an additional layer interposed between the gas diffusion media and the electrically conductive lands, according to one embodiment of the invention.

FIG. 7 is a side view of a product including a gas diffusion media having an upper surface defining a plurality of lands and channels and an electrically conductive material deposited over the lands of the gas diffusion media, according to one embodiment of the invention.

FIG. 8 illustrates a product including a bipolar plate having a substantially flat face and a gas diffusion media with a plurality of electrically conductive lands secured thereto to define a plurality of gas reactant channels, according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

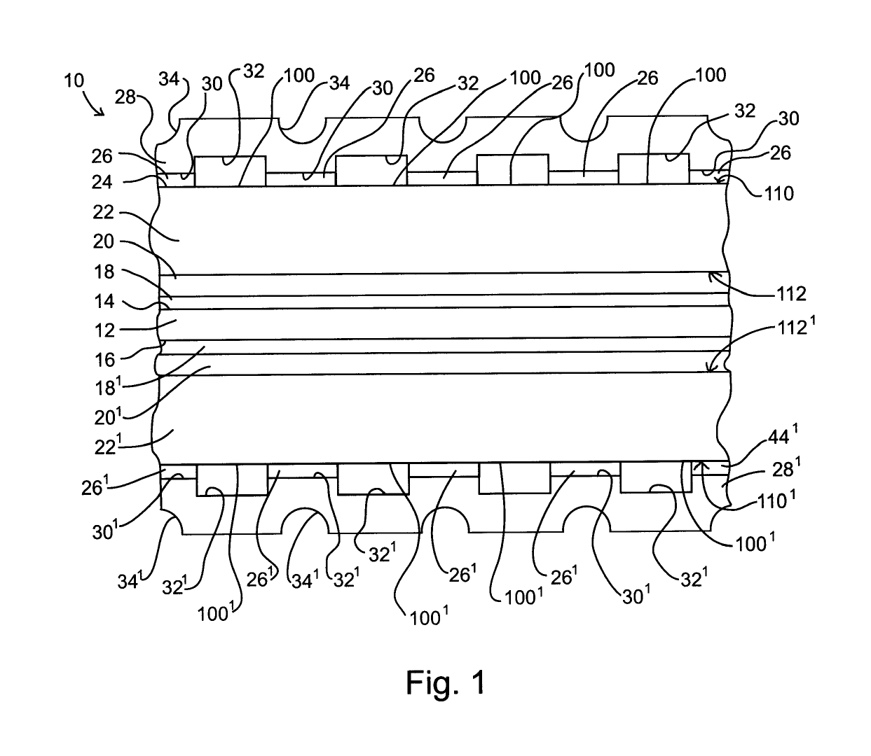

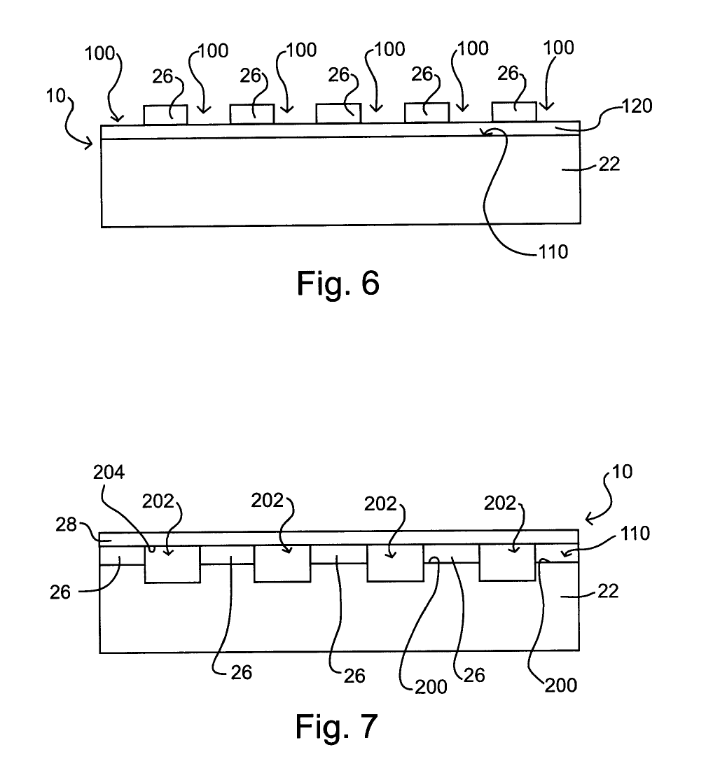

Referring now to FIG. 1, a product 10 according to one embodiment of the invention may include a solid polyelectrolyte membrane 12 having a first face 14 and an opposite second face 16. A first electrode 18 may be placed over the first face 14. For example, the first electrode 18 may be an anode. The anode 18 includes a catalyst to dissociate hydrogen into electrons and protons, catalyst support particles and an ionomer. A microporous layer 20 may be provided over the anode 18. The microporous layer 20 may include particles and a binder, such as carbon particles and polytetrafluoroethylene (PTFE). A gas diffusion media 22 may be provided over the microporous layer 20. The gas diffusion media 22 may be any porous material that is electrically conductive. Exemplary embodiments of the gas diffusion media layer 22 may include materials such as graphitized carbon fiber constructed as papers or felts. The gas diffusion media 22 is constructed and arranged to transport reacting gases to and excess liquid product out of the electrocatalyst layers (anode 18 or cathode 36). The gas diffusion media layer 22 includes a first face 110 and a second face 112 on which the microporous layer 20 is formed. A plurality of electrically conductive lands 26 are provided over the first face 110 of the gas diffusion layer 22. The plurality of electrically conductive lands 26 are secured to the gas diffusion media layer 22, for example, by bonding directly to the first face 110 of the gas diffusion media layer 22 or by bonding to an additional coating such as PTFE on the first face 110. In other embodiments, the electrically conductive lands 26 may be secured to the gas diffusion media layer 22 by an additional layer 120 (shown in FIG. 6) interposed between the electrically conductive lands 26 and the first phase 110 of the gas diffusion media layer 22.

Adjacent electrically conductive lands 26 are spaced apart from each other, for example, by a region 100 of the first face 110 on which no electrically conductive material has been deposited. The electrically conductive lands 26 may be secured to the gas diffusion media layer 22 by physical vapor deposition or electrocoating using an appropriate mask, or by screen-printing. A bipolar plate 28 may be provided over the electrically conductive lands 26. The bipolar plate 28 may include a first face having a plurality of lands 30 and channels 32 formed therein and a second face having a plurality of coolant channels 34 formed therein. In one embodiment of the invention, the electrically conductive lands 26 secured to the gas diffusion media 22 are positioned to be aligned with the lands 30 of the bipolar plate and run generally parallel thereto.

Similar structures are provided underlying the second face 16 of the electrolyte membrane 12. A second electrode 18¹, such as a cathode, is provided underlying the second face 16 of the electrolyte membrane 12. The second electrode 18¹ includes a catalyst for catalyzing a reaction producing water from protons, oxygen and electrons at the cathode 18¹. The catalyst in the cathode 18¹ may be supported by particles, such as carbon particles. An ionomer may be included in the cathode 18¹ in a manner known to those skilled in the art. A second microporous layer 20¹ may be provided underlying the cathode 18¹. A second gas diffusion media layer 22¹ may be provided including a first face 110¹ and an opposite second face 112¹. The second microporous layer 20¹ may be adhered to the second face 112¹ of the second gas diffusion media layer 22¹. A plurality of electrically conductive lands 26¹ are provided secured to the second gas diffusion media layer 22¹. The plurality of electrically conductive lands 261 may be adhered directly to the first face 110¹ of the second gas diffusion media layer 22¹ or an additional layer may be interposed between the electrically conductive lands 261 and the first face 110¹. A second bipolar plate 28¹ may be provided and includes a plurality of lands 30¹ and channels 32¹ formed in a first face and a plurality of cooling channels 34¹ may be provided in a second face. In one embodiment of the invention, the electrically conductive lands 26¹ are aligned with and run generally parallel to the lands 30¹ of the second bipolar plate 28¹. As described above, adjacent electrically conductive lands 26¹ may be spaced apart from each other by a region 100¹ on the first face 110¹ of the second gas diffusion media layer 22¹ on which no electrically conductive material has been deposited.

The electrically conductive lands 26, 26¹ may be made from any electrically conductive material. In various embodiments of the invention, the electrically conductive lands 26, 26¹ may include Ag, Au, Pd, Pt, Rh and/or Ir, and alloys thereof, or RuO₂, IrO₂, or doped metal oxides.

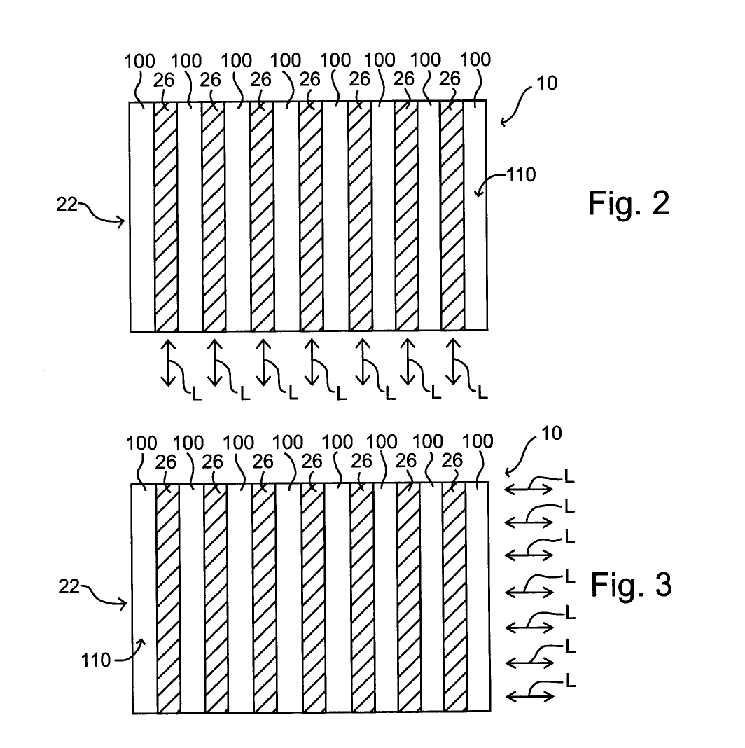

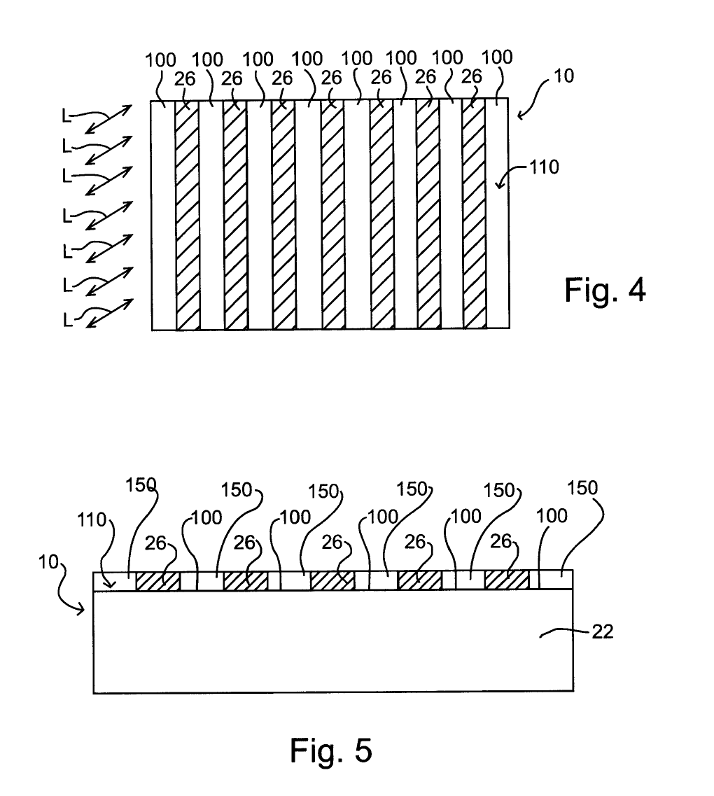

Referring now to FIG. 2, one embodiment of the invention includes a product 10 including a gas diffusion media layer 22 having a plurality of electrically conductive lands 26 secured thereto. That is, the electrically conductive lands 26 are physically or chemically bonded to the gas diffusion media layer 22, and are not merely two components pressed together. Adjacent electrically conductive lands 26 are spaced apart from one another by a region 100, on the first face 110 of the gas diffusion media layer 22, on which no electrically conductive material has been deposited. The electrically conductive lands 26 are aligned with the lands 30 of a bipolar plate and wherein the lands 30 of the bipolar plate have a longitudinal axis shown by the arrows labeled L. The longitudinal axis of a portion of the electrically conductive lands 26 runs generally parallel to the longitudinal axis (L) of a portion of the bipolar plate. In an alternative embodiment, shown in FIG. 3, the electrically conductive lands 26 are positioned such that their longitudinal axis of at least a portion thereof runs generally perpendicular to the longitudinal axis (L) of the lands of a bipolar plate. In still an alternative embodiment, as shown in FIG. 4, the electrically conductive lands 26 are positioned so that their longitudinal axis of at least a portion thereof is skewed with respect to the longitudinal axis of lands (L) of a bipolar plate.

Referring now to FIG. 5, one embodiment of the invention includes a product including a gas diffusion media layer having a first face 110 and a plurality of electrically conductive lands 26 bonded to the first face 110. In one embodiment, a masking material 150 is provided with openings therein and an electrically conductive material is deposited into the openings in the masking material 150 to form the electrically conductive lands 26. Thereafter, the masking material may be removed. The masking material may be of any type known to those skilled in the art including a hard physical mask, or a mask that may be etched or dissolved away.

In an alternative embodiment, shown in FIG. 6, an additional layer 120 is bonded to or adhered to the first face 110 of the gas diffusion media layer 22. Electrically conductive lands 26 are secured to the gas diffusion media layer 22 by bonding the electrically conductive lands 26 to the additional layer 120. The additional layer 120 may be made from a variety of materials which, for example, improve the properties of the gas diffusion media layer or enhance the bonding of the electrically conductive lands 26 to the gas diffusion media layer 22. In one embodiment, the additional layer 120 includes a material to improve water management, such as, a polytetrafluoroethylene coating. In another embodiment, the additional layer 120 includes a thin metal, such as a seed layer to improve the bonding of the electrically conductive lands 26 to the gas diffusion media layer 22.

Referring now to FIG. 7, one embodiment of the invention includes a bipolar plate which may have a substantially flat face 204 and an opposite face 206 which may also be flat or may be constructed to provide a plurality of cooling fluid channels. Alternatively, cooling fluid channels, if needed, may be provided by a variety of means, including depositing a plurality of lands on the second flat face 206 so the bipolar plate 28 and depositing another substantially flat bipolar plate on top of such lands. Alternatively, an undulating piece of metal foil may be placed over the bipolar plate 28 to define a plurality of cooling channels. The gas diffusion media may have a first face 110 which has been stamped, etched or machined to provide a plurality of lands 200 and channels 202. Electrically conductive material 26, such as gold, may be deposited at least on the lands 200 of the gas diffusion media 22.

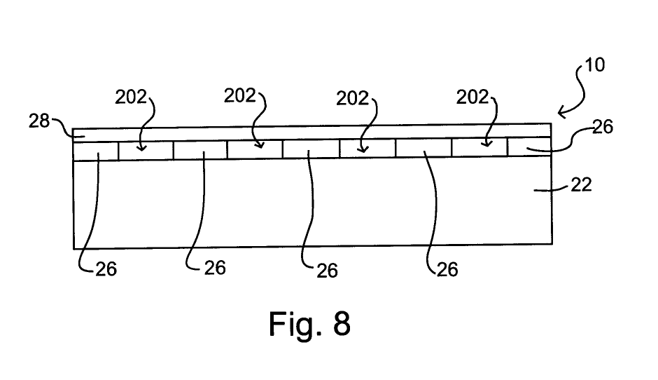

Referring now to FIG. 8, in one embodiment of the invention, a plurality of electrically conductive lands 26 may be deposited on a first face 110 of the gas diffusion media 22. A bipolar plate 28 may be placed over the electrically conductive lands 26 so that a substantially flat face 202 on the bipolar plate faces the electrically conductive lands 26. The electrically conductive lands 26 are spaced apart from each other to provide reacting gas flow channels 202 therebetween.

Referring again to FIG. 1, solid polymer electrolyte membranes 12 useful in the present invention are ion-conductive materials. Suitable membranes useful in the present invention are described in U.S. Pat. Nos. 4,272,353 and 3,134,697, and in the Journal of Power Sources, Volume 29 (1990), pages 367-387. Such membranes are also known as ion exchange resin membranes. The resins include ionic groups in their polymeric structure; one ionic component for which is fixed or retained by the polymeric matrix and at least one other ionic component being a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cation exchange, proton conductive resins is the so-called sulfonic acid cation exchange resin. In the sulfonic acid membranes, the cation exchange groups are sulfonic acid groups which are attached to the polymer backbone.

The formation of these ion exchange resins into membranes or sheets is well known to those skilled in the art. The preferred type is perfluorinated sulfonic acid polymer electrolyte in which the entire membrane structure has ionic exchange characteristics. These membranes are commercially available, and a typical example of a commercially sulfonic perfluorocarbon, proton conductive membrane is sold by E. I. DuPont de Nemours & Company under the trade designation NAFION. Other such membranes are available from Asahi Glass and Asahi Chemical Company. The use of other types of membrane such as, but not limited to, perfluorinated cation-exchange membranes, hydrocarbon based cation-exchange membranes as well as anion-exchange membranes are also within the scope of the invention.

In one embodiment, the electrodes 18, 18¹ may be catalyst layers which may include a group of finely divided carbon particles supporting finely divided catalyst particles such as platinum and an ion conductive material, such as a proton conducting ionomer, intermingled with the particles. The proton conductive material may be an ionomer such as a perfluorinated sulfonic acid polymer. The catalyst materials may include metal such as platinum, palladium, and mixtures of metals such as platinum and molybdenum, platinum and cobalt, platinum and ruthenium, platinum and nickel, and platinum and tin, other platinum transition-metal alloys, and other fuel cell electrocatalysts known in the art.

When the terms “over,” “overlying,” “overlies,” or “under,” “underlying,” “underlies” are used herein with respect to the relative position of one component or layer with respect to a second component or layer, such shall mean that the first component or layer is in direct contact with the second component or layer, or that additional layers or components may be interposed between the first component or layer and the second component or layer.

The above description of embodiments of the invention is merely exemplary in nature and, thus, variations thereof are not to be regarded as a departure from the spirit and scope of the invention.

What is claimed is:

1. A product comprising:
a fuel cell gas diffusion media layer having a first face and an opposite second face;
a plurality of electrically conductive lands secured to the gas diffusion media layer and overlying the first face.

2. A product as set forth in claim 1 wherein the electrically conductive lands are bonded directly to the first face.

3. A product as set forth in claim 1 wherein the electrically conductive lands each comprise at least one of Ag, Au, Pd, Pt, Rh, Ir or alloys thereof.

4. A product as set forth in claim 1 wherein the electrically conductive lands each comprise at least one of RuO₂ or IrO₂.

5. A product as set forth in claim 1 wherein the electrically conductive lands each comprise a doped metal oxide.

6. A product as set forth in claim 1 wherein the plurality of electrically conductive lands comprise Au.

7. A product as set forth in claim 1 further comprising an additional layer interposed between the plurality of electrically conductive lands and the first face of the gas diffusion media layer.

8. A product as set forth in claim 7 wherein the additional layer comprises polytetrafluoroethylene.

9. A product as set forth in claim 7 wherein the additional layer comprises a metal seed layer.

10. A product as set forth in claim 1 wherein adjacent electrically conductive lands are spaced apart by a region on the first face of the gas diffusion media layer on which no electrically conductive land material is deposited.

11. A product as set forth in claim 1 further comprising a bipolar plate including a first face defining a plurality of lands and channels and wherein the lands of the bipolar plate face the electrically conductive land secured to the gas diffusion media layer.

12. A product as set forth in claim 11 wherein the electrically conductive lands each includes a segment having a longitudinal axis which runs generally parallel to the longitudinal axis of a portion of one of the lands of the bipolar plate.

13. A product as set forth in claim 11 wherein the electrically conductive lands each includes a portion having a longitudinal axis running substantially perpendicular to the longitudinal axis of a portion of one of the lands of the bipolar plate.

14. A product as set forth in claim 11 wherein the electrically conductive lands each includes a portion having a longitudinal axis running in a skewed direction to the longitudinal axis of a portion of one of the lands of the bipolar plate.

15. A process comprising providing a fuel cell gas diffusion media layer having a first face and an opposite second face;
selectively securing an electrically conductive material to the gas diffusion media layer overlying the first face and so that a plurality of electrically conductive lands are formed over the first face of the gas diffusion media layer.

16. A process as set forth in claim 15 wherein the securing an electrically conductive material to the gas diffusion media layer comprises chemical vapor deposition of electrically conductive material onto the first face of the gas diffusion media layer.

17. A process as set forth in claim 15 wherein the securing an electrically conductive material to the gas diffusion media layer comprises selectively depositing a masking material on the first face of the gas diffusion media to provide openings between portions of the masking material and depositing the electrically conductive material into the openings in the masking material and onto the first face of the gas diffusion media layer.

18. A process as set forth in claim 17 wherein the depositing the electrically conductive material comprises chemical vapor deposition.

19. A process as set forth in claim 17 wherein the depositing the electrically conductive material comprises electrocoating.

20. A process as set forth in claim 15 wherein the securing electrically conductive material to the gas diffusion media layer comprises screen-printing.

21. A process as set forth in claim 15 wherein the electrically conductive material comprises at least one of Ag, Au, Pd, Pt, Rh, Ir or alloys thereof.

22. A process as set forth in claim 15 wherein the electrically conductive material comprises at least one of RuO₂ or IrO₂.

23. A process as set forth in claim 15 wherein the electrically conductive material comprises a doped metal oxide.

24. A process as set forth in claim 15 wherein the electrically conductive material comprises gold.

25. A process comprising:
providing a fuel cell gas diffusion media layer having a first face and an opposite second face, and wherein the first face of the gas diffusion media layer defining a reactant gas flow field comprising a plurality of lands and channels;
selectively securing an electrically conductive material to the gas diffusion media layer overlying at least the lands of the first.

26. A process as set forth in claim 25 further comprising forming the lands and channels in the first face of the gas diffusion media layer comprising stamping, etching or machining a surface of a gas diffusion media material.

27. A process as set forth in claim 25 wherein the securing an electrically conductive material to the gas diffusion media layer comprises chemical vapor deposition of electrically conductive material onto the first face of the gas diffusion media layer.

28. A process as set forth in claim 25 wherein the securing an electrically conductive material to the gas diffusion media layer comprises selectively depositing a masking material on the first face of the gas diffusion media to provide openings between portions of the masking material and depositing the electrically conductive material into the openings in the masking material and onto the first face of the gas diffusion media layer.

29. A process as set forth in claim 28 wherein the depositing the electrically conductive material comprises chemical vapor deposition.

30. A process as set forth in claim 28 wherein the depositing the electrically conductive material comprises electrocoating.

31. A process as set forth in claim 25 wherein the securing electrically conductive material to the gas diffusion media layer comprises screen-printing.

32. A process as set forth in claim 25 wherein the electrically conductive material comprises at least one of Ag, Au, Pd, Pt, Rh, Ir or alloys thereof.

33. A process as set forth in claim 25 wherein the electrically conductive material comprises at least one of RuO₂ or IrO₂.

34. A process as set forth in claim 25 wherein the electrically conductive material comprises a doped metal oxide.

35. A process as set forth in claim 25 wherein the electrically conductive material comprises gold.
